(19) United States
(12) Patent Application Publication
(10) Pub. No.: US 2006/0271440 A1
(43) Pub. Date: Nov. 30, 2006

(54) DVD based internet advertising

(76) Inventors: Scott Spinucci, Wilkes Barre, PA (US); Jeffrey Williams, Archbald, PA (US)

Correspondence Address: LAWRENCE P. ZALE, 334 SOUTH FRANKLIN ST., WILKES-BARRE, PA, 18703-0113, US

(21) Appl. No.: 11/445,391

(22) Filed: May 31, 2006

Related U.S. Application Data
(60) Provisional application No. 60/673,129, filed on May 31, 2005.

(51) Int. Cl. G07G 1/14; G06F 17/00

(52) U.S. Cl. 705/14; 715/501.1; 715/500.1

(57) ABSTRACT

A device and method to direct a user to a Website to purchase products or services employs a DVD with prestored media segments and associated Website addresses of each advertiser site. The DVD is distributed to users who insert them into their host computer connected to the Internet. A program runs which allows the user to select media segments. If the user would like to purchase the product or service relating to the media segment being played, the user clicks a button. Once clicked, the user jumps to the advertiser's site allowing the user to purchase the product or service. The purchase information, along with the IP address and optionally information relating to the media segments viewed and the disk ID may be collected and analyzed. Statistics relating to this information is provided to the advertiser.

### CROSS-REFERENCE TO RELATED APPLICATIONS

This application is a continuation-in-part of U.S. Provisional Patent Application Ser. No. 60/673,129 filed May 31, 2005 entitled “Klik2Buy”. The present application incorporates this application in its entirety and claims priority from this case.

### BACKGROUND OF THE INVENTION

1. Field of the Invention

The present invention relates to a DVD based method and apparatus for directing internet traffic to desired locations.

2. Discussion of Related Art

In the past there were conventional methods of advertising new videos, movies and software through paper means such as magazines and newspapers. These did not provide any feedback on who was actually viewing the ads.

Advertising advanced to offering products on the Internet. There previously have been video clips and trailers which were placed on DVDs. These required one to then start a browser and type in the Website location to view the product.

Advertising that is provided close in time and proximity to the point at which a user buys a product, is very effective. Therefore, an advertising media which allows one to view a product and buy immediately has very good results.

Since DVDs are read only, they are not interactive. They typically play videos but do not employ the capability of interactively implementing the purchase of an item.

Internet marketing reaches those who are on the Internet. There is still a population who do not regularly use the Internet. As simple as it is to use, there still are people who do not know how to find products that they would like to purchase. These people however are not intimidated with DVDs, which they use often.

Currently, there is a need for a simple advertising device which reaches many people and easily and immediately allows a person to purchase the advertised product or service directly from a DVD when placed in a personal computer with DVD capabilities.

### SUMMARY OF THE INVENTION

The present invention may be embodied as a method for directing users to advertiser sites each having a unique Website address using a DVD having prestored media segments each associated with a Website address, comprising the steps of:
a) inserting the disk into a host computer connected to the internet;
b) interacting with a user to select a media segment to play;
c) playing the selected media segment;
d) displaying trigger areas which, when selected, indicate a desire to purchase a product or service associated with the media segment playing;
e) monitoring when a user clicks on a trigger area;
f) pausing the media segment, after a trigger area has been clicked;
g) jumping to the Website address associated with the media segment to execute an on-line purchase of a product or service identified in the media segment, after a trigger area has been clicked;
h) sending the IP address of said host computer to the advertiser site after a trigger area has been clicked; and
i) returning from Website address after a trigger area has been clicked.

The present invention may also be embodied as a device for directing a user on a host computer connected to the internet to advertising sites, comprising:
a) An optical data disk which at least a portion is compatible with conventional DVD players and computers, the disk having pre-stored media segments from at least one advertiser, the disk having pre-stored Website address for a Website of a plurality of advertiser sites each associated with a media segment, the disk being adapted to be played on said host computer, the disk having a program adapted to:
   i. interact with a user to select a media segment to play;
   ii. play the selected media segment with trigger areas;
   iii. monitor when a user clicks on a trigger area;
   iv. pause the media segment, after a trigger area has been clicked;
   v. jump to the Website address associated with the media segment to execute an on-line purchase of a product or service identified in the media segment, after a trigger area has been clicked;
   vi. send the IP address of said host computer to the advertiser site after a trigger area has been clicked; and
   vii. return from Website address after a trigger area has been clicked.

The present invention may also be embodied as a method of marketing a product or service comprising the steps of:
a) distributing an advertising disk to a user, the disk having a pre-stored unique ID, media segments and web addresses corresponding to each media segment adapted to be loaded onto a host computer having an IP address connected to the Internet;
b) providing an interface having a video screen and at least one trigger area to the user to allow the user to select a media segment to view on the viewing screen and instructions on selecting the trigger area to purchase a product or service related to the media segment;
c) monitoring the trigger areas to identify when a trigger area has been selected;
d) if the trigger area has been selected, then:
   i. identifying the web address corresponding to the media segment;
   ii. opening a browser and going to the site identified by the web address; and
   iii. completing a purchase at the site identified by the web address.

The present invention is an approach for users to purchase products and services by clicking on an audio/visual A/V item, e.g. video residing on a DVD video formatted disk. This is operational when the DVD is inserted into a personal computer (PC) with Internet access. When the user clicks on an advertiser's video element a generic web browser is launched and the advertiser's predetermined Website is opened. Simultaneously code is sent to a prearranged address alerting the advertiser where the “click” to the Website came from, i.e. the DVD.

### OBJECTS OF THE INVENTION

It is an object of the present invention to provide a product which can be easily distributed that plays video and audio information for advertising purposes.

It is another object to the present invention to provide a product which displays video information and directs the user to particular Websites.

It is another object of the present invention to provide a method of directing web traffic to a specific advertiser.

It is an object of the present invention to provide a product which conforms to conventional DVD standards and may be played on a conventional DVD player as well as on a computer.

### BRIEF DESCRIPTION OF THE DRAWINGS

A complete understanding of the present invention may be obtained by reference to the accompanying drawings, when considered in conjunction with the subsequent detailed description, in which:

FIG. 1 is an overall view of one embodiment of a DVD based Internet traffic direction device according to the present invention.

FIG. 2 is a flowchart illustrating the functioning of one embodiment of the present invention.

FIGS. 3a and 3b together are a flowchart illustrating the functioning of an alternative embodiment of the present invention.

### DETAILED DESCRIPTION OF THE PRESENT INVENTION

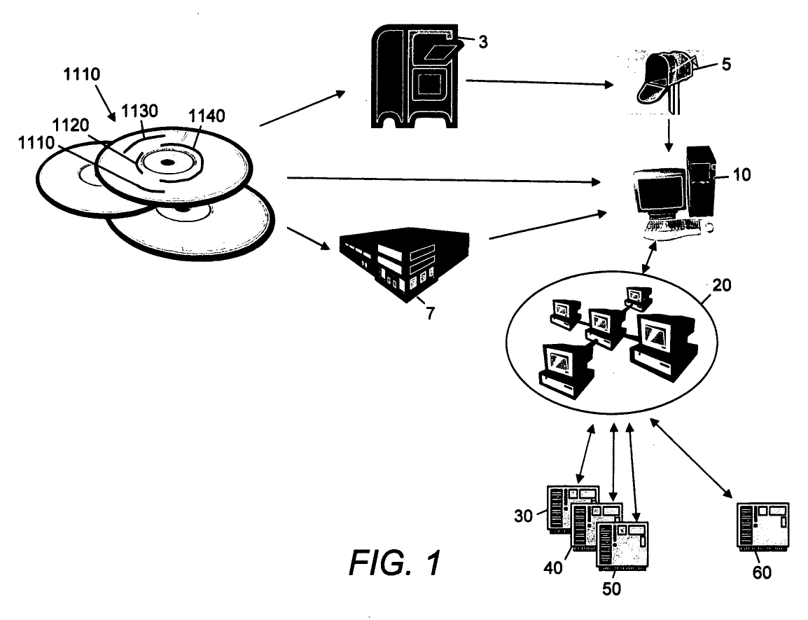

FIG. 1 is an overall view of one embodiment of Internet traffic direction device according to the present invention. In this embodiment, a disk 1100 is created with media segments 1110. These media segments 1110 could be still images, graphics, animation, video and/or audio representations of advertisements, movie clips, software, video games, or other products.

Disk 1100 also has links 1120, which are typically web site addresses, pointing to specific Websites. Each link 1120 is associated with a media segment 1110. There may be several links per segment 1110, each associated with a different portion of the segment 1110.

There is also a pre-stored program 1140 on the disk 1100 which causes the system to function.

The program 1140 is a software layer that “taps” into a DVD player (and driver software) already resident on host computer 10. This creates an invisible, interactive layer that resides over the DVD video having full DVD functionality, plus all of functionality of the Web through the internet connection. The program 1140 is preferably “Klik2buy™” software. Program 1140 is takes over control the DVD player, pausing it when a user clicks on a trigger areas to buy a product or service, and restarting when the transaction is completed. The program 1140 thereby functions an interactive layer or platform, below which other media may be displayed and controlled.

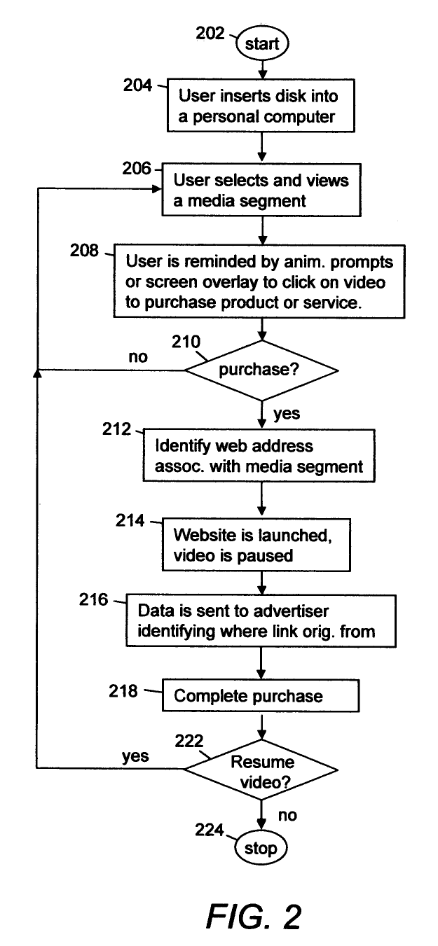

FIG. 2 is a flowchart illustrating the functioning of the present invention. The invention 1000 will be described with reference to FIGS. 1 and 2.

The process starts at step 202. This disk 1100 is distributed to users via the mail system 3, 5. They may also be distributed through a retail establishment 7. Disks 1100 may be included in magazines, newspapers, sent by direct mailings, handed out at retail outlets for little or no charge, or other distribution methods.

In step 204, the user inserts the disk 1100 in a computer 10 connected to the Internet 20. The program 1140 (Klik2Buy software) starts up as an auto startup program.

The user is provided with a user interface, having a video screen, which allows the user to select media segments 1110 to view.

In step 206, the user selects media segment 1110 to view through the use of program 1140. The program 1140 opens a browser and the selected media segment 1110 is viewed

In step 208, the user is reminded by animated prompts or screen overlays to click on the video screen to purchase the product or service.

In step 210 the program 1140 running on computer 10 monitors the target area to identify if the user clicks on a target area indicating that the user would like to purchase the product or service related to the media segment 1110 currently being played. The target area may be the video screen, a button, image or other visual object. Different portions of a media segment may be associated with different web addresses.

If no click on a target area is detected (“no”), no purchase is desired and processing continues at step 206.

If a click is detected on one of the user areas (“yes”), a purchase is desired of a product or service related to the media segment 1110 being played. Processing then continues at step 212.

In step 212, the program identifies a Website address 1120 associated with the media segment 1110 (and locations within the media segment 1120) is playing.

In step 214, the media segment 1110 being played is paused and the location within the media segment 1110 noted. A Website at the identified web address 1120 is launched.

In step 216, the IP address of computer 10, and optionally, unique disk ID 1130 are sent to an advertiser Website server 30 which sponsored the media segment 1110. The advertiser Website 30 receives the IP address knowing where the link originated. Optionally other information, such as the unique disk ID, the time of the transaction and other information may be sent. Some of this information may require an additional decoder 31 added to the advertiser Website 30.

This structure provides advertiser 30 with information as to the sales which occur, as they occur, the disk from which they originated, the network location of the host computer 10. This important information may be used in determining the value of media segments 1110, and the effectiveness of the advertising.

In step 218, the user interacts with the Website through computer 10 to complete the on-line purchase.

In step 222 the user is allowed to continue watching the media segment 1110 (“yes”) and processing returns to step 206.

If the user chooses not to continue viewing the media segment 1110, then the process stops at step 224.

There are typically many advertisers, such as 40 and 50 each which sponsors different media segments 1110.

For example when a user clicks on a target area when the media segment 1110 sponsored by advertiser 40 is playing, then advertiser 40 is notified with the information described above. This is the same for other advertisers, such as advertiser 50.

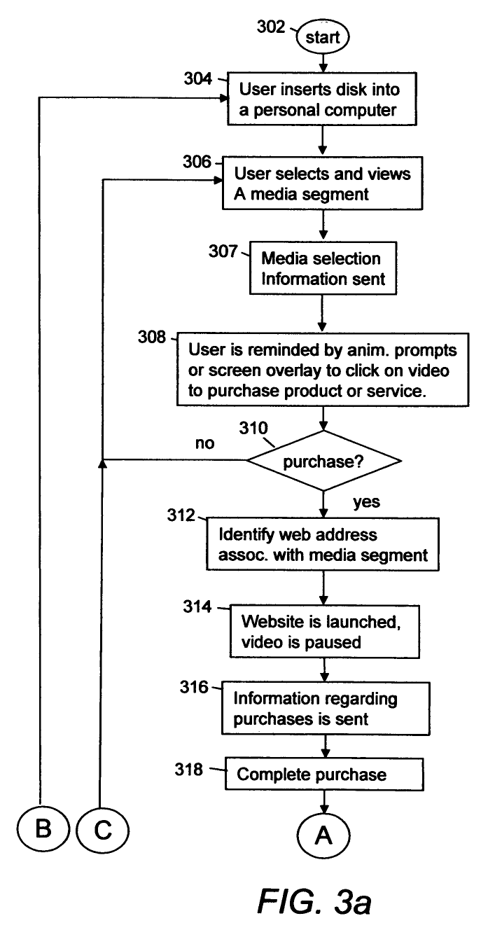

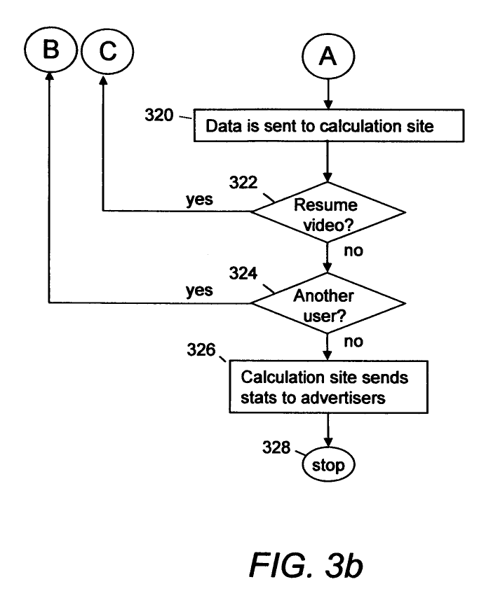

FIGS. 3a and 3b together are a flowchart illustrating the functioning of an alternative embodiment of the present invention.

The process starts at step 302. As in the previous embodiment, this disk 1100 is distributed to users through magazines, newspapers, direct mailings, distributed at retail outlets, or other conventional distribution methods.

In step 304, the user inserts the disk 1100 in a computer 10 connected to the Internet 20. The program 1140 starts up as an auto startup program.

Program 1140 provides the user with an interface, having a video screen, and buttons which are target areas that cause a function to occur when the user clicks on one. The user selects media segments 1110 to view.

In step 306, the user views the selected media segment 1110.

Optionally, in step 307, the IP address of host computer 10 and information relating to the media segments selected by the user for viewing are either sent immediately through the internet to a processing site, or stored on local host computer 10 and sent to a processing site when the session has been completed. This information indicates the media segments selected by the user to view. The processing site may be a Website address (or alternative port) on an advertiser site 30 which is different from the Website address for viewing the advertiser's Website. The processing site may also be a calculation site 60 which is not affiliated with the advertiser. The processing sites must have prestored intelligence to decode the information sent to them. Other information may additionally be sent, such as the disk ID 1130 such that any statistics may be associated with a given disk 1100. This allows tracking of each disk throughout its lifecycle.

Additional information, such as the subject matter of the disk 1100, when the disk was released, through which channel it was released (mail, handout, magazine, etc.), may be encoded in the disk ID and/or the data sent to the processing sites.

In step 308, the user is reminded by animated prompts or screen overlays to click on the video screen to purchase the product or service.

In step 310 the program 1140 running on computer 10 monitors the target areas to identify if the user clicks on a target area indicating that the user would like to purchase the product or service related to the media segment 1110 currently being played. If no click on a target area is detected (“no”), then processing continues at step 306.

If a click is detected on the user area (“yes”), then processing continues at step 312.

In step 312, the program identifies a Website address 1120 for purchase of a product or service of an advertiser site 30 associated with the media segment 1110 (and locations within the media segment 1110) is playing.

In step 314, the media segment 1110 being played is paused and the location within the media segment 1110 noted. A browser is launched by program 1140 and jumps the user to the web address 1120 associated with the media segment 1110 being played.

In step 316, data regarding the purchase information is sent to the processing sites as described in step 307 above. Again, calculations, statistics and other information may be collected, processed for a number of users and provided to each advertiser on a periodic, or as requested basis. This provides valuable information on the effectiveness of the advertising.

In step 318, the user interacts with the Website through computer 10 to complete the on-line purchase.

In step 320, the unique disk ID 1130, the IP address of computer 10 and the Website address of an advertiser 30 which sponsored the media segment 1110 are sent to a decoder 61 of a calculation Website 60.

This gives calculation unit 60 information as to the sales which occur, the disk from which they originated the network location of the host computer 10.

In step 322 the user is allowed to continue watching the media segment 1110 (“yes”) and processing returns to step 306.

If the user chooses not to continue viewing the media segment 1110, then the processing continues at step 324.

In step 324 it is determined if there is another user to process. If so (“yes”), then processing continues at step 304.

After many users have been processed, statistics relating to the sales may be calculated for each advertiser. This information is analyzed by calculation unit 60 to identify correlations and patterns.

If not (“no”), then in step 326 calculation Website 60 sends the calculated information to the advertisers 30, 40 and 50. The process stops at step 328.

In an alternative embodiment, information regarding other actions of the user, such as the media segments 1110, the number of times each was viewed, the time in which it was viewed by each user, may be collected and sent to the calculation unit 60. This allows calculation site 60 to calculate statistics regarding this information which shall also be sent to the advertiser sites 30, 40, 50.

The information calculated for example, may be the number of users viewing each of the media segments 1110 sponsored by the advertisers, the products and services purchased, the time it took for each purchase, the relative percentage of each media segment 1110 viewed for a given advertiser, a map of where the ‘hits’ originated, information showing how many hits occurred per disk, and where the disk traveled, etc. This information is valuable in determining the most effective way to market a product or service and also may be used in determining pricing of the advertisements.

This embodiment in which information is only sent to the advertisers after calculation unit has received input from multiple users requires less Internet traffic, and provides meaningful analysis of a volume of data. This is important information used in determining the value of media segments 1110, and the effectiveness of the advertising.

In the first embodiment, information regarding the user's selections is sent to a predetermined web address at the advertiser's server 30. Also, the Website is opened which may be at the advertiser server 30. These typically are at two different web addresses or ports.

In the second embodiment, the user's selections are sent to a predetermined web address at the calculation site server 60. However, the Website of the advertiser server 30 is opened. Any information, statistics or calculations performed at the calculation site 60 are forwarded to the advertiser server 30.

In a third embodiment, the user's selections are sent to the predetermined web address at the calculation site server 60. Data indicating a link to the advertiser server 30 is also sent to the calculation site 60. All traffic is then routed though calculation server 60 and redirected to the advertiser site 30. This simplifies the system and allows all traffic to flow through calculation site 60, and calculation site 60 to monitor the traffic and provide statistics relating to the traffic.

While several presently preferred embodiments of the novel invention have been described in detail herein, many modifications and variations will now become apparent to those skilled in the art. It is, therefore, to be understood that the appended claims are intended to cover all such modifications and variations as fall within the true spirit of the invention.

What is claimed is:

1. A method for directing users to advertiser Websites each having a unique Website address using a DVD having prestored media segments each associated with a Website address, comprising the steps of:
a) inserting the disk into a host computer with DVD capabilities connected to the internet;
b) interacting with a user to select a media segment to play;
c) playing the selected media segment;
d) displaying trigger areas which, when selected, indicate a desire to purchase a product or service associated with the media segment playing;
e) monitoring when a user clicks on a trigger area;
f) pausing the media segment, after a trigger area has been clicked;
g) jumping to the Website address associated with the media segment to execute an on-line purchase of a product or service identified in the media segment, after a trigger area has been clicked;
h) sending the IP address of said host computer to the advertiser site after a trigger area has been clicked; and
i) returning from Website address after a trigger area has been clicked.

2. The method of claim 1 further comprising the steps of:
a) collecting the IP addresses and purchase information for a plurality of users; and
b) creating statistics of the collected information.

3. The method of claim 2 further comprising the steps of:
a) collecting information relating to the media segments played for a plurality of users; and
b) creating statistics of the collected information.

4. The method of claim 2 further comprising the steps of:
a) storing a unique disk ID on the disk;
b) creating statistics of the collected information and the unique IDs of the disks.

5. An interactive software layer for directing a user on a host computer having an embedded DVD player and connected to the internet, to advertising sites, comprising:
a) an optical data disk which at least a portion is compatible with conventional DVD players and computers, the disk having pre-stored media segments from at least one advertiser, the disk having pre-stored Website address for a Website of a plurality of advertiser sites each associated with a media segment, the disk being adapted to be played on said host computer, the disk having a program adapted to:
i. interact with a user to select a media segment to play;
ii. cause said DVD player to play the selected media segment with trigger areas;
iii. monitor when a user clicks on a trigger area;
iv. when trigger area has been clicked:
pause the DVD player and media segment, after a v. jump to the Website address associated with the media segment to execute an on-line purchase of a product or service identified in the media segment, after a trigger area has been clicked;
send the IP address of said host computer to the advertiser site; and
return from Website address.

6. The interactive software layer of claim 5, wherein the program is further adapted to:
a) monitor the media segments selected;
b) send information related to the media segments selected to the advertiser site.

7. The interactive software layer of claim 5, wherein:
a) a unique disk ID is prestored on the disk; and
b) the program is further adapted to send the unique disk ID to the advertiser site.

8. The interactive software layer of claim 5, wherein the disk is further adapted to:
start a browser then jump to the Website address.

9. A method of marketing a product or service comprising the steps of:
a) distributing an advertising disk to a user, the disk having a pre-stored unique ID, media segments and web addresses corresponding to each media segment adapted to be loaded onto a host computer having an IP address connected to the Internet;
b) providing an interface having a video screen and at least one trigger area to the user to allow the user to select a media segment to view on the viewing screen and instructions on selecting the trigger area to purchase a product or service related to the media segment;
c) monitoring the trigger areas to identify when a trigger area has been selected,
d) if the trigger area has been selected, then:
i. identifying the web address corresponding to the media segment;
ii. opening a browser and going to the site identified by the web address; and
iii. completing a purchase at the site identified by the web address.

10. The method of claim 9 further comprising the step of:
sending the media segment selection and disk ID information to the advertiser just after it was selected.

11. The method of claim 9 further comprising the step of:
storing the media segment selection and the disk ID information and sending the stored information to the advertiser when the session has ended.

12. The method of claim 9 further comprising the step of:
sending the media segment selection and disk ID information to the calculation site just after it was selected.

13. The method of claim 9 further comprising the step of:
storing the media segment selection and the disk ID information and sending the stored information to the calculation site when the session has ended.

14. The method of claim 9 further comprising the step of:
a) sending the purchase and disk ID information to the calculation site just after the purchase;
b) storing the purchase and disk ID information after the purchase and sending this information to the calculation site when the session has ended.

15. The method of claim 9 further comprising the step of:
sending the IP address of the host computer.

16. The method of claim 9 further comprising, at the calculation site, the step of:
accumulating media segment selection, disk ID and IP address information from a plurality of users and calculating statistical information regarding the media segments viewed for each advertiser.

17. The method of claim 9 further comprising, at the calculation site, the step of:
accumulating purchase, disk ID and IP address information from a plurality of users and calculating statistical information regarding the purchases for each advertiser.

18. The method of claim 9 further comprising, at the calculation site, the step of:
reporting to the advertisers the calculated statistical information relating to each advertiser.
